(19) United States
(12) Patent Application Publication
(10) Pub. No.: US 2025/0159547 A1
(43) Pub. Date: May 15, 2025

(54) LOW LATENCY, LOW LOSS, SCALABLE THROUGHPUT QUEUING AND MARKING

(71) Applicant: Cisco Technology, Inc., San Jose, CA (US)

(72) Inventors: Brian D. Hart, Sunnyvale, CA (US); Binita Gupta, San Diego, CA (US); Jerome Henry, Pittsboro, NC (US); Malcolm M. Smith, Richardson, TX (US); Pascal Thubert, Roquefort-les-Pins (FR); Jean Philippe Vasseur, Issy Les Moulineaux (FR)

(73) Assignee: Cisco Technology, Inc., San Jose, CA (US)

(21) Appl. No.: 18/947,480

(22) Filed: Nov. 14, 2024

Related U.S. Application Data
(60) Provisional application No. 63/598,930, filed on Nov. 14, 2023.
(60) Provisional application No. 63/640,176, filed on Apr. 29, 2024.

(51) Int. Cl. H04W 28/02

(52) U.S. Cl. CPC H04W 28/0289; H04W 28/0284

(57) ABSTRACT

Low Latency, Low Loss, Scalable Throughput (L4S) queuing and marking and, specifically, L4S parameters for congestion marking and a new congestion flag for predicted congestion events may be provided. Providing L4S marking can comprise determining, in layer 2, a packet is experiencing congestion. A L4S marking request is sent to layer 3 to request congestion marking of the packet. The packet is marked in layer 3 for congestion experienced A L4S marking response comprising the marked packet is then sent to layer 2.

### RELATED APPLICATION

Under provisions of 35 U.S.C. § 119(e), Applicant claims the benefit of and priority to U.S. Provisional Application No. 63/598,930, filed Nov. 14, 2023, the disclosure of which is incorporated herein by reference in its entirety. Furthermore, under provisions of 35 U.S.C. § 119(e), Applicant claims the benefit of U.S. Provisional Application No. 63/640,176 filed Apr. 29, 2024, which is incorporated herein by reference.

### TECHNICAL FIELD

The present disclosure relates generally to providing Low Latency, Low Loss, Scalable Throughput (L4S) queuing and marking and specifically to providing L4S parameters for congestion marking and a new congestion flag for predicted congestion events.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings to deliver network access to all of the network-enabled devices in the building. With the creation of the wireless AP, network users can add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Low Latency, Low Loss, Scalable Throughput (L4S) queuing and marking in accordance with aspects of the present disclosure.

FIG. 2A and FIG. 2B collectively form FIG. 2, a block diagram of a network model for L4S marking in accordance with aspects of the present disclosure.

FIG. 3 is a block diagram of a queue congestion model for L4S marking in accordance with aspects of the present disclosure.

FIG. 4 is a block diagram of a frame for setting a congestion flag based on predicted congestion in accordance with aspects of the present disclosure.

FIG. 5 is a flow chart of a method for L4S marking in accordance with aspects of the present disclosure.

FIG. 6 is a flow chart of a method for setting a congestion flag based on predicted congestion in accordance with aspects of the present disclosure.

FIG. 7 is a block diagram of a computing device in accordance with aspects of the present disclosure.

FIG. 8 is a block diagram of a communications device in accordance with aspects of the present disclosure.

### DETAILED DESCRIPTION

### Overview

Low Latency, Low Loss, Scalable Throughput (L4S) queuing and marking and, specifically, L4S parameters for congestion marking and a new congestion flag for predicted congestion events may be provided. Providing L4S marking can comprise determining, in layer 2, a packet is experiencing congestion. A L4S marking request is sent to layer 3 to request congestion marking of the packet. The packet is marked in layer 3 for congestion experienced A L4S marking response comprising the marked packet is then sent to layer 2.

Utilizing the congestion flag can comprise predicting or otherwise determining there is congestion or that there will be congestion. The congestion flag of a frame can be set in response to the predicted congestion to indicate that there is detected congestion or predicted congestion that will occur. The frame can then be sent to an Access Point (AP), and the AP can identify that there is that there is detected congestion or predicted congestion that will occur based on the congestion flag.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The Open System Interconnection model of networking includes seven abstraction layers for communications between systems. Layer 2 is the data link layer, and layer 3 is the network layer. The data link layer comprises the Logical Link Control (LLC) sublayer and the Medium Access Control (MAC) sublayer and is responsible for transferring data between nodes on a network segment across the Physical (PHY) layer. The network layer is responsible for transferring packets from a source to a destination via one or more networks.

Low Latency, Low Loss, Scalable Throughout (L4S) is an architecture and protocol described in the Internet Engineering Task Force (IETF) standards (e.g., the IETF Request for Comment (RFC) 9330, 9331, 9332). L4S is implemented to provide low queuing latency, low congestion loss, and scalable throughput control for streaming video, multiplayer games, and other real-time applications. By handling data packet processing and reducing network congestion, L4S minimizes delays caused by queue bloat and enables smoother and more efficient data transmission.

Integrating L4S with existing network infrastructures and ensuring compatibility with a wide range of applications can be challenging. For example, L4S may require multiple features compatible with its requirements for integration or assume the existence of the features for operation. These features and/or other L4S requirements may not be supported by existing legacy devices manufactured before the implementation of L4S. The features can include the existence of a scalable congestion control at a sender host capable of keeping an average time for congestion signals as the flow rate scales, a packet identifier at the Internet Protocol (IP) layer to be used as an explicit congestion control signaling protocol, support for detailed Explicit Congestion Notification (ECN) feedback, the capability to isolate traffic in separate queues (e.g., at one or more points in the networking stack) so L4S traffic can be kept on a shallow queue, and a conditional priority scheduler at one or more points in the networking stack that can give preference to L4S traffic over other types of traffic. L4S can have different requirements based on the infrastructure of the network L4S is being implemented in.

The Institute of Electrical and Electronics Engineers (IEEE) 802.11 is a set of layer 2, including MAC, specifications for implementing Wireless Local Area Network (WLAN) communication. L4S is a layer 3 technology, while, IEEE 802.11 standards, such as for buffering or queuing packets, are directed to layer 2. Thus a system designed to provide compliant layer 2 (e.g., as described in IEEE 802.11) support for L4S may require the layer 2 entity to perform layer 3 operations and notify a new layer 3 entity within the system's networking stack of changes or operations needed to support L4S. New primitives (e.g., a set of one or more commands or instructions) can be used to request packet marking at layer 3 and to send the marked packets back to layer 2.

Additionally, to utilize L4S, systems may perform marking and/or otherwise notify devices of L4S support. For example, systems can mark packets they send to other systems using an ECN field. The ECN field can include one or more bits in a packet header that can be set to indicate L4S support, indicate congestion, etc. For example, an ECN field with bits set to 00 indicates that the traffic is not ECN-capable, 01 indicates that the traffic is L4S capable, 10 indicates that the traffic is ECN-capable with no congestion detected, and 11 indicates Congestion Experienced (CE). Thus, a source device can use marking (e.g., using the ECN field) to indicate that the source device is L4S capable to other devices (e.g., network devices processing the source device's packets) and when congestion is experienced.

At layer 3, marking such as setting the ECN field is performed in forward traffic, and the transport layer (i.e., layer 4) can, based on the ECN marking, send a request to the source to slow down in response to the congestion. This process can be reactive, end-to-end, and slow to react, whereas radio layer collisions have shorter terms and require fast reaction. Congestion events on wireless networks can be short term and related to predictable physical events. Thus, congestion could be avoided if the sending system is notified or otherwise determines there is congestion quickly. A layer 2 entity may set the ECN field to indicate congestion in some embodiments to reactively mark packets in response to detected congestion. Machine learning techniques can be utilized to detect the congestion or predict upcoming congestion. Further, a new ECN flag and methods for setting the new flag based on a predicted short-term congestion event can also enable systems to avoid congestion.

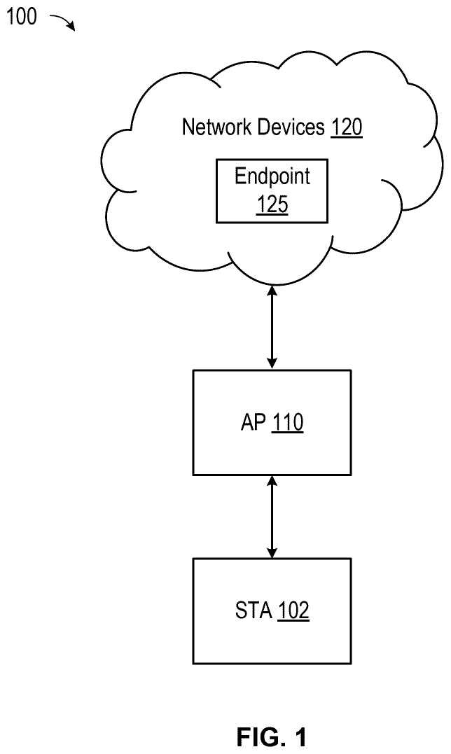

FIG. 1 is a block diagram of an operating environment 100 for L4S queuing and marking in accordance with aspects of the present disclosure. The operating environment 100 includes a Station (STA) 102, an AP 110, and network devices 120. The STA 102 can be any device (e.g., a smart phone, a tablet, a personal computer, a server, etc.) that connects to the network, such as to communicate with other devices on the network (e.g., network devices 120). The AP 110 may enable devices within range of the AP 110, including the STA 102, to connect to devices and applications of the network, including the network devices 120. The network devices 120 can be devices that can be communicated with via the network (e.g., via the Internet) and/or other network devices. The network devices 120 includes an endpoint 125, and the endpoint 125 may be a L4S capable device communicating with the STA 102 in some embodiments.

The AP 110 and/or one or more of the network devices 120 can support L4S by using marking request primitives and marking response primitives to request congestion marking at layer 3 for layer 3 packets queued at layer 2 and sending marked packets back to layer 2 for queuing. Sending devices, such as the STA 102, the AP 110, and so on can predict or otherwise detect congestion using machine learning techniques, as will be described in further detail herein. The STA 102, the AP 110, and/or one or more of the network devices 120 can support L4S for predicted or otherwise detected congestion or upcoming congestion (e.g., short-term congestion) by supporting the marking request primitives and marking response primitives and/or using an ECN flag to indicate the detection of the congestion or upcoming congestion. In some embodiments, the STA 102, the AP 110, and/or one or more of the network devices 120 can predict or otherwise determine the presence short-term congestion using machine learning methods.

Providing L4S marking for example can comprise determining, in layer 2, a MAC packet is experiencing congestion. A MAC packet may include a MAC Service Data Unit (MSDU), an Aggregate MSDU (AMSDU) which contains one or more MSDUs, a MAC Protocol Data Unit (MPDU) which contains an MSDU or an AMSDU, or an Aggregate MPDU (AMPDU) which contains one or more MPDUs. Thus, a MAC packet contains one or more MSDUs. Each MSDU contains a header, such as a LLC header, followed by a Data Link Service Data Unit (DLSDU) (i.e., a layer 3 packet). In embodiments, a L4S marking request for the MAC packet is sent (e.g., in an MAC-aware and LLC-aware way) to the co-located layer 3 entity (or a logical instance thereof) to request congestion marking of the layer 3 packets therein. The MAC packet's layer 3 packets are marked (typically “in-place” in the same memory) selectively by the layer 3 entity to indicate congestion experienced. For example, the ECN field may be set to indicate congestion. Thus, the MAC packet is now modified, for example at multiple locations for multiple layer 3 packets (i.e., marked for every instance of a layer 3 packet of the MAC packet). A L4S marking response and the marked MAC packet is then returned to the co-located layer 2. In certain implementations, the LLC and layer 3 entities may be organized to be in close proximity to, or in line with, the MAC queues.

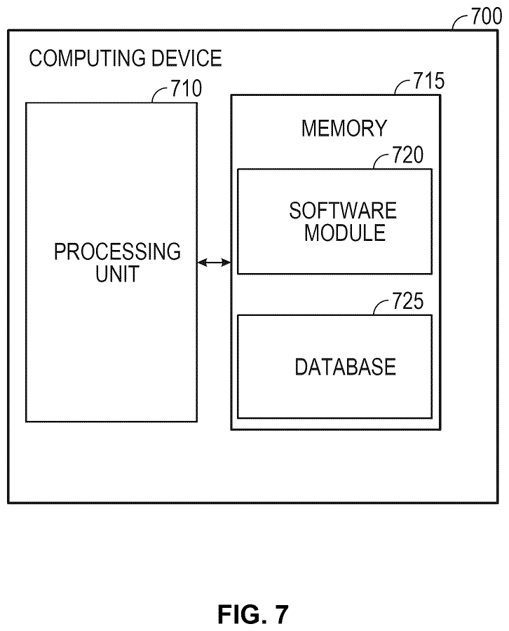

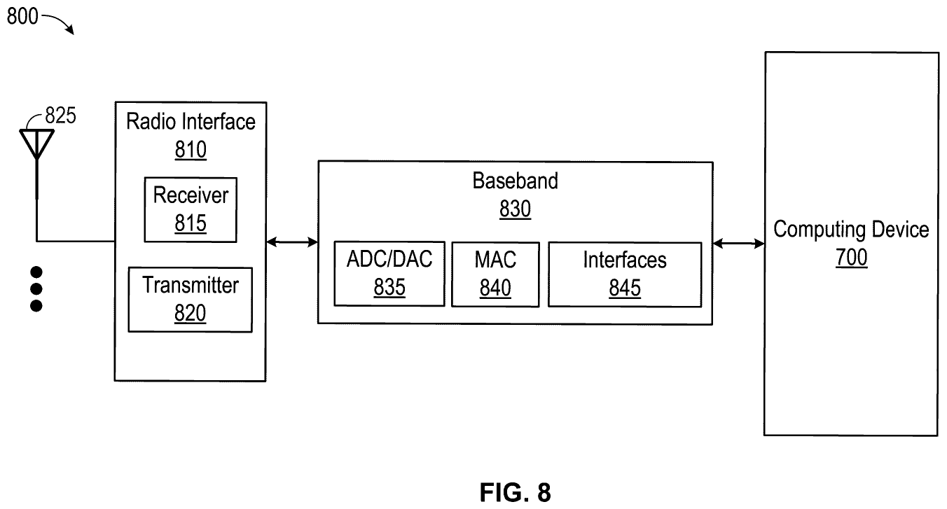

The elements described above of the operating environment 100 (e.g., the STA 102, the AP 110, the network devices 120, the endpoint 125, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 7 and 8, the elements of the operating environment 100 may be practiced in a computing device 700 and/or communications device 800.

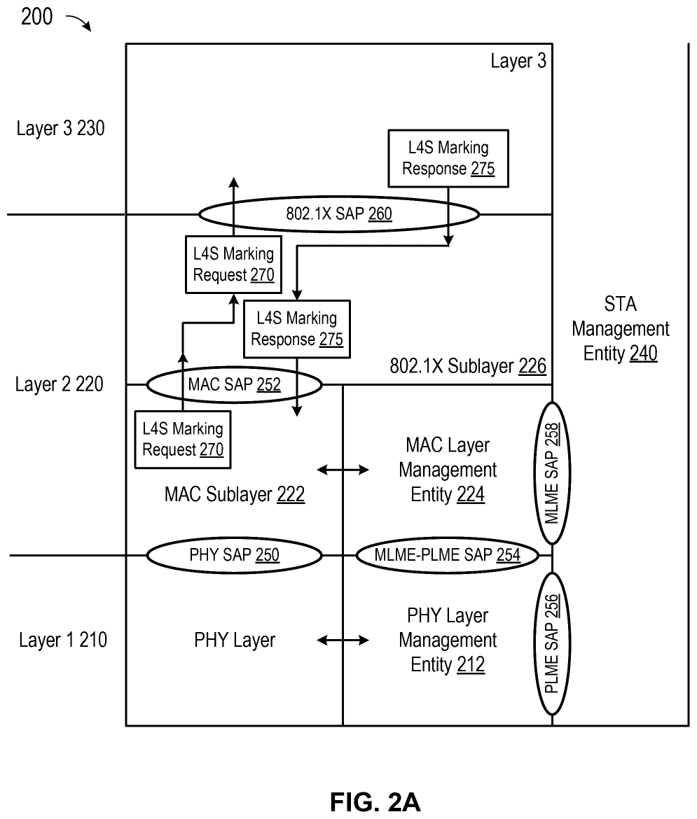

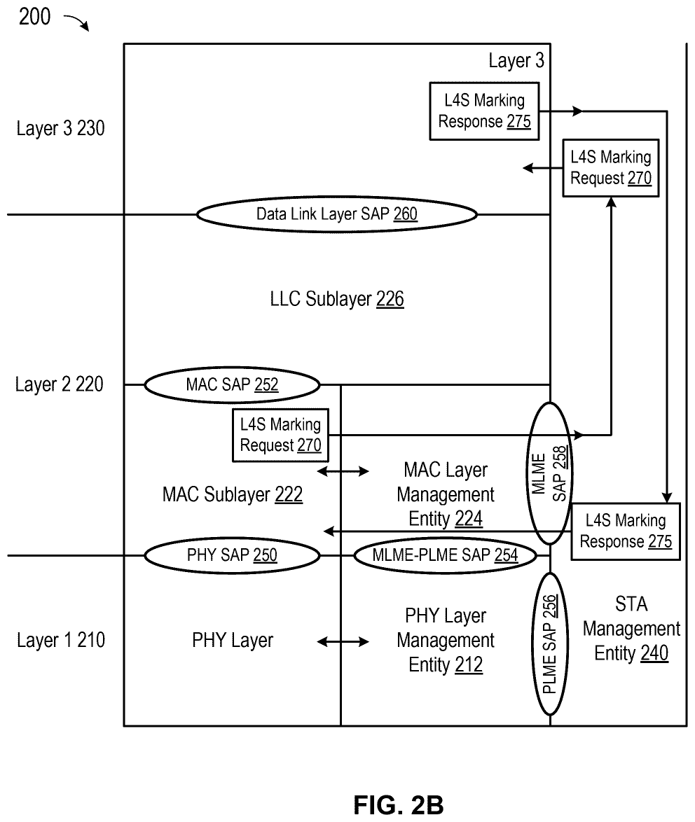

FIG. 2A and FIG. 2B collectively form FIG. 2, a block diagram of a network model 200 for L4S marking. The network model 200 can be implemented in the AP 110 and/or other devices (e.g., one or more network devices 120) supporting L4S. The network model 200 includes layer 1 210 (i.e., the PHY layer) with a PHY Layer Management Entity (PLME) 212, layer 2 220 (i.e., the data link layer) with the MAC sublayer 222, a MAC Layer Management Entity (MLME) 224, and the LLC sublayer 226, and layer 3 230 (i.e., the network layer). The PLME 212 and the MLME 224 can provide layer management service interfaces for invoking layer management functions. The LLC sublayer 226 may operate at layer 2 220 and may, for example, run the Extensible Authentication Protocol (EAP) to allow communication between a client, authenticator, and authentication server. The LLC sublayer 226 can add headers (e.g., Virtual Local Area Network tags as described by IEEE 802.1Q), set EtherType fields, and/or the like. Thus, to find the ECN field in a packet, an entity may need to be aware of any extra bytes before the ECN field by communicating with the LLC sublayer 226.

The network model 200 also includes a STA Management Entity (SME) 240. The SME 240 may be a layer-independent entity residing in a separate management plane. Generally, the SME 240 can be responsible for gathering layer dependent status information from the various layer management entities (e.g., the PLME 212, the MLME 224), setting the values of layer-specific parameters, and the like. The SME 240 can perform such functions on behalf of general system management entities and implement standard management protocols.

The network model 200 further includes a PHY Service AP (SAP) 250, a MAC SAP 252, a MLME-PLME SAP 254, a PLME SAP 256, a MLME SAP 258, and a data link layer SAP 260. The various entities within the network model 200 can interact in various ways via an SAP across which defined primitives can be exchanged. The PHY SAP 250 enables layer 1 210 and the MAC sublayer 222 to interact, the MAC SAP 252 enables the MAC Sublayer 222 and the LLC sublayer 226 to interact, the MLME-PLME SAP 254 enables the PLME 212 and MLME 224 to interact, the PLME SAP 256 enables the PLME 212 and the SME 240 to interact, the MLME SAP 258 enables the MLME 224 and the SME 240 to interact, and the data link layer SAP 260 enables the LLC sublayer 226 and layer 3 230 to interact. In some embodiments, the SAP enabling layer 2 220 to interact with layer 3 230 may be a different SAP, such as the MAC SAP 252.

To support L4S, the AP 110 and/or another device using the network model 200 can use a L4S marking request 270 and a L4S marking response 275 for layer 2 220 to indicate to layer 3 230 to mark one or more packets with a congestion notification (e.g., ECN marking) and for layer 3 230 to notify layer 2 220 that the one or more packets have been marked and is being returned. In embodiments, the L4S marking request 270 and the L4S marking response 275 are primitives that can be exchanged via one or more SAPs and/or one or more entities. For example, a L4S capable packet (e.g., a MAC packet) may experience congestion at layer 2 220, such as in a queue, and the L4S marking request 270 can be sent to layer 3 230 with the packet for marking. Layer 3 230 can mark the packet and send the L4S marking response 275 to layer 2 220 and the marked packet back to a queue. The L4S marking request 270 can include queue information for the corresponding L4S flow, such as a queue depth (e.g., the absolute depth or percentage occupancy of the queue), a Head-of-Line (HOL) queue delay, and/or the like. The L4S marking request 270 can also include other characteristics of the corresponding L4S flow (e.g., a Received Signal Strength Indicator (RSSI) of the associated device, such as the STA 102), a recommended value for the congestion marking (e.g., a recommendation for the ECN field in the IP header within the MSDU), and/or the like. In further embodiments, queue information, other characteristics of the corresponding L4S flow, a recommended value for the congestion marking, and/or the like may be sent to layer 3 230 via a separate primitive or other mechanism.

In example implementations, the L4S marking request 270 includes a source address indicating the source device, a destination address indicating the destination device, routing information, data, priority information, a format (e.g., MSDU format), a Stream Classification Service Identifier (SCSID), and a queue dialog token. Similarly, the L4S marking response 275 includes a source address, a destination address, routing information, data, priority information, a format, a SCSID, and a queue dialog token in example implementations. The queue dialog token can be used to insert the packet back in the same place in the queue in the MAC sublayer 222 when the packet is sent up to layer 3 230.

In some embodiments, the MAC sublayer 222 issues one L4S marking request 270 and receives one L4S marking response 275 per MSDU of a MAC packet. The address or offset of the start of one MSDU in the MAC packet may be passed to the LLC sublayer 226 and then passed from the LLC sublayer 226 to layer 3 230. The processing may an optimized combination across sublayers in example implementations. If the changes are made in-place or in the same memory, then the L4S marking response 275 may be an indication that marking has completed. In another embodiment, an array of the start addresses or offsets of one or more MSDUs in a MAC packet are sent to the LLC sublayer 226 and then passed from the LLC sublayer 226 to layer 3 230. The processing may an optimized combination across sublayers in example implementations. If the changes are made in-place or in the same memory, then the L4S marking response 275 for the array of MSDUs may be an indication that marking has completed.

The L4S marking request 270 and the L4S marking response 275 primitives can be implemented as one or more of software function calls, software function callbacks, hardware processing, and/or the like. One or more L4S marking requests 270 and/or L4S marking responses 275 may be combined or otherwise sent together to handle multiple packets (e.g., MSDUs) simultaneously or otherwise together. Layer 3 230 can receive inputs via the LLC sublayer 226 or the SME 240 and mark the ECN field of the associated packets according to these inputs (e.g., the L4S marking request 270).

In FIG. 2A, the L4S marking request 270 is sent from the MAC sublayer 222 to the LLC sublayer 226 via the MAC SAP 252. The LLC sublayer 226 can modify the associated packet (e.g., adding header bytes, strip header bytes) and adjust an address or offset to identify the ECN field of the packet. The L4S marking request 270 can then be forwarded to layer 3 230 via the data link layer SAP 260. Alternatively, a new L4S marking request 270 is sent from the LLC sublayer 226 to layer 3 230 via the data link layer SAP 260. The new L4S marking request 270 can accommodate modification performed on the associated packet, such as including an adjusted address or offset to identify the ECN field of the packet.

Once the packet is marked in layer 3 230, layer 3 230 can send a L4S marking response 275 comprising the marked packet to the LLC sublayer 226 via the data link layer SAP 260. The L4S marking response 275 can then be forwarded to the MAC sublayer 222 via the MAC SAP 252. Alternatively, a new L4S marking response 275 is sent from the LLC sublayer 226 to the MAC sublayer 222 via the MAC SAP 252. Thus, the L4S marking request 270 primitives and the L4S marking response 275 primitives can connect via the LLC sublayer 226 to provide layer 3 230 access to packets for L4S processing (e.g., marking). When the MAC sublayer 222 receives an MSDU that has been marked, if the MSDU resides in an MPDU or and AMPDU then the Frame Check Sequence (FCS) of the MPDU may need to be recalculated.

Since IEEE 802.1 may add layer-specific header and/or tail fields, these can be stripped from the L4S marking request 270 and the L4S marking response 275 primitives by including an offset to the start of the IP header. Once layer 3 230 modifies the packet according to the input (e.g., the L4S marking request 270), the modified packet can be returned to the LLC sublayer 226. Returning the packet to the LLC sublayer 226 may ensure that the original 802.1 headers and/or footers are preserved. The packet can then be sent to MAC sublayer 222 for processing the packet (e.g., queuing and sending the packet). Some headers and/or footers (e.g., with an FCS) may need to be recalculated.

FIG. 2B illustrates another configuration for sending the L4S marking request 270 to layer 3 230 and sending the L4S marking response 275 to layer 2 220. In FIG. 2B, the L4S marking request 270 is sent from the MLME 224 to the SME 240 via the MLME SAP 258. The L4S marking request 270 can then be forwarded to layer 3 230 (e.g., via a layer 3 management entity SAP). Alternatively, a new L4S marking request 270 is sent from the SME 240 to layer 3 230. Once the packet is marked in layer 3 230, layer 3 230 can send a L4S marking response 275 to the SME 240 (e.g., via a layer 3 management entity SAP). The L4S marking response 275 can then be forwarded to the MLME 224 via the MLME SAP 258. Alternatively, a new L4S marking response 275 is sent from the SME 240 to the MLME 224 via the MLME SAP 258. Thus, the L4S marking request 270 primitives and the L4S marking response 275 primitives can connect via the SME 240 to provide layer 3 230 access to packets for L4S processing. The STA management entity 240 may communicate with the LLC sublayer 226 to update modify the header of one or more packets, update the address, offset, and/or the like to locate the ECN field.

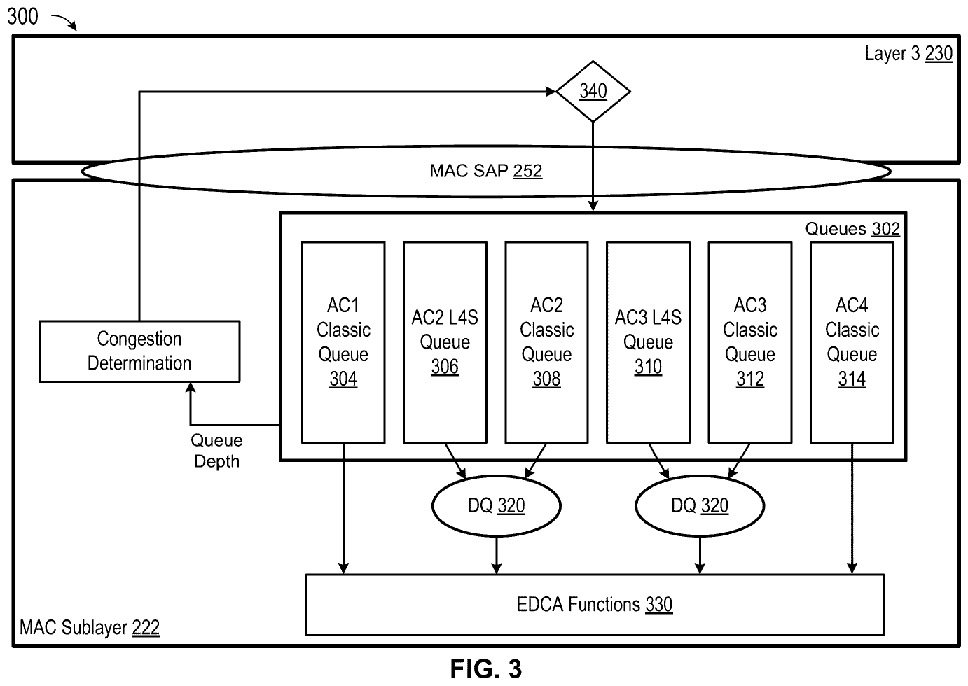

FIG. 3 is a block diagram of a queue congestion model 300 for L4S marking. The queue congestion model 300 includes queues 302 in the MAC sublayer 222. The queues 302 can include a first Access Category (AC) classic queue 304, a second AC L4S queue 306, a second AC classic queue 308, a third AC L4S queue 310, a third AC classic queue 312, and a fourth AC classic queue 314. In some embodiments, the first AC is a background AC, the second AC is a best effort AC, the third AC is a video AC, and the fourth AC is a voice AC. The MAC sublayer 222 can also include Dual Queue (DQ) switches 320. The second AC L4S queue 306 and the second AC classic queue 308 can both send the queued traffic from the queues to a DQ switch 320, and the third AC L4S queue 310 and the third AC classic queue 312 can send the queued traffic from the queues 302 to a DQ switch 320. The MAC sublayer 222 can also include Enhanced Distributed Channel Access (EDCA) functions 330 for the first AC classic queue 304, DQ switches 320, and the fourth AC classic queue 314 to send queued traffic for subsequent transmission toward the respective endpoint. The queues 302 can be implemented at the MAC sublayer 222 to enable control for L4S flow scheduling with low queuing delay and high output.

In certain embodiments, when a MAC packet experiences congestion at in the second AC L4S queue 306 or the third AC L4S queue 310, the MAC packet can be sent to layer 3 230 for marking. For example, the L4S marking request 270 can be sent to layer 3 230 as shown in FIG. 2A or FIG. 2B to request marking of the layer 3 packets within the MAC packet. The L4S marking request 270 can include queue information, other characteristics of the corresponding L4S flow, a recommended value for the congestion marking, and/or the like. Layer 3 230 can mark the packet and return the marked packet to the queues 302 for queuing and transmission to the target endpoint. For example, a differentiated services (DiffServ) 340 can receive the L4S marking request 270 and the MAC packet, mark the packet, and return the marked MAC packet (e.g., with layer 3 packets marked) via a L4S marking response 275 to the MAC sublayer 222. The DiffServ 340 can return the L4S marking response 275 as shown in FIG. 2A or FIG. 2B. In other embodiments, the DiffServ 340 will not handle the L4S marking request 270 and the packet, and one or more other layer 3 230 entities will receive the L4S marking request 270 and the packet, mark the packet, and return the marked packet (e.g., with layer 3 packets marked) via a L4S marking response 275 to the MAC sublayer 222.

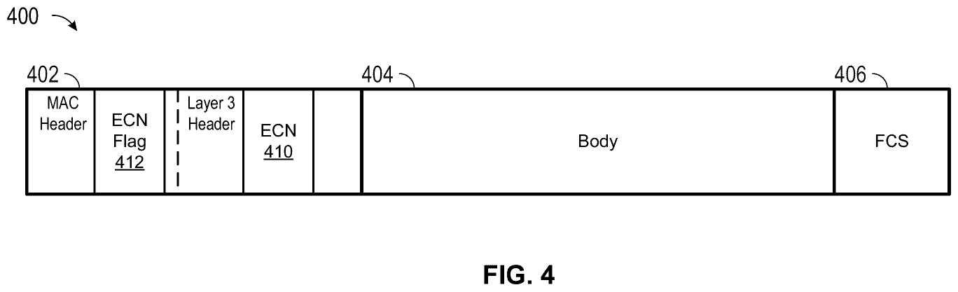

FIG. 4 is a block diagram of a frame 400 for setting a congestion flag based on predicted congestion. The frame 400 may be a MAC frame with a header 402, a body 404, and an FCS field 406. The header 402 can comprise a MAC header, a LLC header, a layer 3 header, and/or the like and include an ECN field 410 and an ECN flag field 412. The ECN field 410 can include two bits for marking, including to indicate congestion. For example, setting the ECN field 410 to 00 indicates that the traffic is not ECN-capable, 01 indicates that the traffic is L4S capable, 10 indicates that the traffic is ECN-capable, and 11 indicates CE, when congestion is experienced.

The ECN flag field 412 may be one or more bits and can be set by a sending device, such as the STA 102 when sending the frame 400 to the endpoint 125 (e.g., via one or more hops). The position of the ECN flag field 412 anywhere in the header 402, including before or after the ECN field 410. The ECN flag field 412 can be set to indicate short-term congestion is experienced or expected. Thus, the sending device can report congestion to the transport layer using the ECN flag field 412, thereby reporting congestion to layer 3 230 similarly that IP ECN is reported to layer 4. In certain embodiments, the ECN flag field 412 is in the MAC header, and the ECN field 410 is in the layer 3 header.

The sending device, such as the STA 102, can detect congestion or predict congestion will occur by observing the delay in the transmission queue, the number of drops and/or retries, backoff delays, static layer 2 220 Key Performance Indicators (KPIs), and/or the like. The sending device can also utilize machine learning techniques to determine that congestion exists or will occur. In general, machine learning is concerned with the design and the development of techniques that take data (e.g., network statistics, performance indicators) as input, and recognize complex patterns in the data. One common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used to classify new data points. Often, M is a statistical model, and the cost function is inversely proportional to the likelihood of M, given the input data.

The STA 104 and/or other sending devices can employ machine learning techniques such as Nearest Neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), Support Vector Machines (SVMs), Generative Adversarial Networks (GANs), Long Short-Term Memory (LSTM), Gated Recurrent Units (GRUs), logistic or other regression, Markov models or chains, Principal Component Analysis (PCA) (e.g., for linear models), Singular Value Decomposition (SVD), Multi-Layer Perceptron (MLP) Artificial Neural Networks (ANNs) (e.g., for non-linear models), replicating reservoir networks (e.g., for non-linear models, typically for timeseries), random forest classification, and/or the like.

In further implementations, the STA 102 and/or other sending devices may use one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, Generative Adversarial Networks (GANs), Large Language Models (LLMs), other transformer models, and/or the like.

The sending device may specify for the machine learning technique what characterizes a state of congestion (e.g., threshold for a transmit queue size, percentage of packet loss, etc.) and the set of input variables. The state of congestion can be dynamic (e.g., the queue size may grow while still providing high quality of service to the traffic). The target state of congestion for setting the ECN flag field 412 may be tied to upper layer such as the transport layer packet loss, Service Level Agreement (SLA) violation (e.g., crossing delay, loss and jitter thresholds) provided by a third-party controller, and/or the like. Thus, upon detecting an event, such as an SLA violation, the sending device could use as input one or more of the selected variables. The criteria for specifying a KPI or other variable to monitor to determine a state of congestion and set the ECN flag field 412 may be configured by the sending device, a user, another network device, and/or the like. Thus, machine learning techniques can be trained to determine congestion for a given environment and used locally on wireless devices. In certain embodiments, the machine learning techniques can be used to determine congestion and subsequently request marking and perform marking, such as via the operations described herein (e.g., as described with respect to FIG. 1, FIG. 2A, FIG. 2B, FIG. 3, etc.). In other embodiments, the sending device may set the ECN flag field 412 in response to the determined congestion.

In some embodiments, L4S marking and/or setting the ECN flag field 412 may be based on quality of service. For example, if only lower quality of service frames 400 may be affected by the predicted congestion, then the sending device may only set the ECN flag field 412 in lower quality of service frames 400. When the sending device is a STA such as the STA 102, the STA 102 may also set a state that is associated with the quality of service level and indicate that the congestion is happening or predicted to happen. When sending the next frame 400 at the corresponding quality of service level, the ECN flag field 412 of the associated frame 400 is set and reported to the transport layer and treated as an ECN notification in the transport header.

The receiving device, such as the AP 110, can read the ECN field 410 and/or the ECN flag field 412 to determine the congestion indicated by the sending device and sets the congestion marking in the IP header(s) of the packet. The receiving device may also set the ECN field 410 in the IP header(s) of the uplink and downlink packets if the AP 110 detects congestion on its own side. Thus, sending devices can proactively mark frames 400 for experienced or predicted congestion for faster congestion marking.

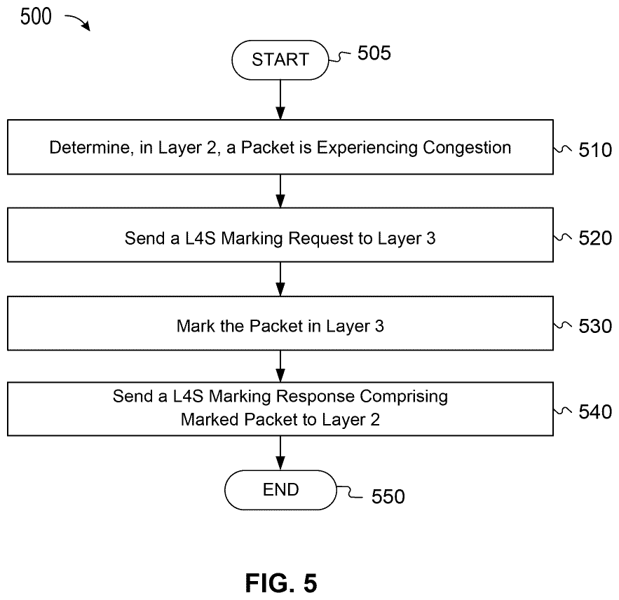

FIG. 5 is a flow chart of a method 500 for L4S marking in accordance with aspects of the present disclosure. The method 500 will be described with operations being performed by the AP 110, but other devices (e.g., the STA 102) may perform the method 500 in other embodiments. Method 500 begins at starting block 505 and proceed to operation 510. In operation 510, it is determined in layer 2 that a packet is experiencing congestion. For example, the AP 110 determines in the MAC sublayer 222 that a packet in a L4S queue is experiencing congestion. The packet may be a MAC packet, such as a MDSU, an AMSDU, a MPDU, an AMPDU, and/or the like.

In operation 520, a L4S marking request is sent to layer 3. For example, the AP 110 sends a L4S marking request 270 to layer 3 230. In some embodiments, the L4S marking request 270 can include queue information for a corresponding L4S flow, characteristics of the corresponding L4S flow, a recommended value for congestion marking, and/or the like. The request may also include the start of every MSDU in the MAC packet, there may be one request per MSDU in the packet, or the networking stack may only mark certain MSDUs.

The AP 110 can send the L4S marking request 270 according to FIG. 2A in certain embodiments. Thus, the AP 110 can send the L4S marking request 270 from the MAC sublayer 222 to the LLC sublayer 226 and send the L4S marking request 270 from the LLC sublayer 226 to layer 3 230. The 110 can send the L4S marking request 270 according to FIG. 2B in other embodiments. Thus, the AP 110 can send the L4S marking request 270 from the MLME 224 to the SME 240 and send the L4S marking request 270 from the SME 240 to layer 3 230.

In operation 530, the packet is marked for congestion experienced. For example, the AP 110 marks the packet in layer 3 230. In operation 540, a L4S marking response comprising the marked packet is sent to layer 2. For example, the AP 110 sends the L4S marking response 275 including the marked packet to layer 2 220. The AP 110 can send the L4S marking response 275 according to FIG. 2A in certain embodiments. Thus, the AP 110 can send the L4S marking response 275 from layer 3 230 to the LLC sublayer 226 and send the L4S marking response 275 from the LLC sublayer 226 to the MAC sublayer 222. The 110 can send the L4S marking response 275 according to FIG. 2B in other embodiments. Thus, the AP 110 can send the L4S marking response 275 from layer 3 230 to the SME 240 and send the L4S marking response 275 from the SME 240 to the MLME 224. In example implementations, the LLC and layer 3 entities may be organized to be in close proximity to, or inline with, the MAC queuing.

In certain embodiments, the method 500 can include receiving a frame 400 with the ECN flag field 412 set to indicate predicted congestion from the STA 102 or another sending device. The STA 102 or other sending device is operable to predict congestion according to the methods described above with respect to FIG. 4, such as based on delay in a transmission queue, one or more drops, one or more retries, a backoff delay, layer 2 KPIs, a prediction generated by a machine learning technique, and/or the like. Method 500 can conclude at ending block 550.

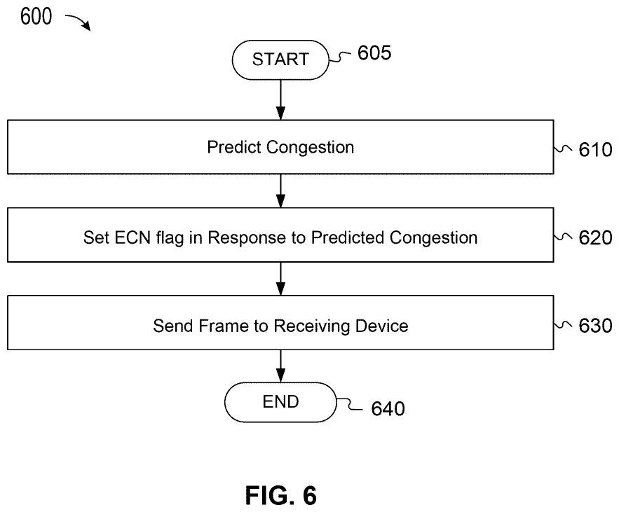

FIG. 6 is a flow chart of a method 600 for setting a congestion flag based on predicted congestion in accordance with aspects of the present disclosure. Method 600 begins at starting block 605 and proceed to operation 610. In operation 610, congestion is predicted. For example, a sending device (e.g., an STA, AP, mesh STA, etc.), such as the STA 102, determines there is congestion or that there will be congestion. The STA 102 can predict to the congestion according to the methods described above with respect to FIG. 4.

In operation 602, an ECN flag is set in response to predicted congestion. For example, the STA 102 sets the ECN flag field 412 of a frame 400 to indicate that there is detected congestion or predicted congestion that will occur. In operation 630, the STA 102 sends the frame 400 to a receiving device (e.g., the AP 110). The receiving device can then identify that the STA 102 determined there is congestion or will be congestion and adjust operation accordingly. Method 600 can conclude at ending block 640.

FIG. 7 is a block diagram of a computing device 700. As shown in FIG. 7, computing device 700 may include a processing unit 710 and a memory unit 715. Memory unit 715 may include a software module 720 and a database 725. While executing on processing unit 710, software module 720 may perform, for example, processes for L4S queuing and marking with respect to FIGS. 1-6. Computing device 700, for example, may provide an operating environment for the STA 102, the AP 110, the network devices 120, the endpoint 125, and the like. The STA 102, the AP 110, the network devices 120, the endpoint 125, and the like may operate in other environments and are not limited to computing device 700.

Computing device 700 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 700 may comprise any computer operating environment, such as hand-held devices, multiprocessor systems, microprocessor-based or programmable sender electronic devices, minicomputers, mainframe computers, and the like. Computing device 700 may also be practiced in distributed computing environments where tasks are performed by remote processing devices. The aforementioned systems and devices are examples, and computing device 700 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 700 on the single integrated circuit (chip).

FIG. 8 illustrates an implementation of a communications device 800 that may implement one or more of the STA 102, the AP 110, the network devices 120, the endpoint 125, etc., of FIGS. 1-6. In various implementations, the communications device 800 may comprise a logic circuit. The logic circuit may include physical circuits to perform operations described for one or more of the STA 102, the AP 110, the network devices 120, the endpoint 125, etc., of FIGS. 1-6, for example. As shown in FIG. 8, the communications device 800 may include one or more of, but is not limited to, a radio interface 810, baseband circuitry 830, and/or the computing device 700.

The communications device 800 may implement some or all of the structures and/or operations for the STA 102, the AP 110, the network devices 120, the endpoint 125, etc., of FIGS. 1-6, storage medium, and logic circuit in a single computing entity, such as entirely within a single device. Alternatively, the communications device 800 may distribute portions of the structure and/or operations using a distributed system architecture, such as a client station server architecture, a peer-to-peer architecture, a master-slave architecture, etc.

A radio interface 810, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 810 may include, for example, a receiver 815 and/or a transmitter 820. The radio interface 810 may include bias controls, a crystal oscillator, and/or one or more antennas 825. In additional or alternative configurations, the radio interface 810 may use oscillators and/or one or more filters, as desired.

The baseband circuitry 830 may communicate with the radio interface 810 to process, receive, and/or transmit signals and may include, for example, an Analog-To-Digital Converter (ADC) for down converting received signals with a Digital-To-Analog Converter (DAC) 835 for up converting signals for transmission. Further, the baseband circuitry 830 may include a baseband or PHYsical layer (PHY) processing circuit for the PHY link layer processing of respective receive/transmit signals. Baseband circuitry 830 may include, for example, a MAC processing circuit 840 for MAC/data link layer processing. Baseband circuitry 830 may include a memory controller for communicating with MAC processing circuit 840 and/or a computing device 700, for example, via one or more interfaces 845.

In some configurations, PHY processing circuit may include a frame construction and/or detection module, in combination with additional circuitry such as a buffer memory, to construct and/or deconstruct communication frames. Alternatively or in addition, MAC processing circuit 840 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
determining, in layer 2, a packet is experiencing congestion;
sending a Low Latency, Low Loss, Scalable Throughput (L4S) marking request to layer 3 to request congestion marking of the packet;
marking the packet in layer 3 for congestion experienced; and
sending a L4S marking response comprising the marked packet to layer 2.

2. The method of claim 1, wherein sending the L4S marking request to layer 3 comprises:
sending the L4S marking request from a Medium Access Control (MAC) sublayer to a Link Layer Control (LLC) sublayer; and
sending the L4S marking request from the LLC sublayer to layer 3.

3. The method of claim 2, wherein sending the L4S marking response comprises:
sending the L4S marking response from layer 3 to the LLC sublayer; and
sending the L4S marking response from the LLC sublayer to the MAC sublayer.

4. The method of claim 1, wherein sending the L4S marking request to layer 3 comprises:
sending the L4S marking request from a MAC Layer Management Entity (MLME) to a Station (STA) Management Entity (SME); and
sending the L4S marking request from the SME to layer 3.

5. The method of claim 4, wherein sending the L4S marking response comprises:
sending the L4S marking response from layer 3 to the SME; and
sending the L4S marking response from the SME to the MLME.

6. The method of claim 1, wherein the L4S marking request comprises any one of (i) queue information for a corresponding L4S flow, (ii) characteristics of the corresponding L4S flow, (iii) a recommended value for congestion marking, or (iv) any combination of (i)-(iii).

7. The method of claim 1, further comprising:
receiving from a sending device a frame with an Explicit Congestion Notification (ECN) flag field set to indicate congestion, wherein the sending device is operable to predict congestion based on any one of (i) a delay in a transmission queue, (ii) one or more drops, (iii) one or more retries, (iv) a backoff delay, (v) layer 2 Key Performance Indicators, (vi) a prediction generated by a machine learning technique, or (vii) any combination of (i)-(vi).

8. A system comprising:
a memory storage; and
a processing unit coupled to the memory storage, wherein the processing unit is operative to:
determine, in layer 2, a packet is experiencing congestion;
send a Low Latency, Low Loss, Scalable Throughput (L4S) marking request to layer 3 to request congestion marking of the packet;
mark the packet in layer 3 for congestion experienced; and
send a L4S marking response comprising the marked packet to layer 2.

9. The system of claim 8, wherein to send the L4S marking request to layer 3 comprises to:
send the L4S marking request from a Medium Access Control (MAC) sublayer to a Link Layer Control (LLC) sublayer; and
send the L4S marking request from the LLC sublayer to layer 3.

10. The system of claim 9, wherein to send the L4S marking response comprises to:
send the L4S marking response from layer 3 to the LLC sublayer; and
send the L4S marking response from the LLC sublayer to the MAC sublayer.

11. The system of claim 8, wherein to send the L4S marking request to layer 3 comprises to:
send the L4S marking request from a MAC Layer Management Entity (MLME) to a Station (STA) Management Entity (SME); and
send the L4S marking request from the SME to layer 3.

12. The system of claim 11, wherein to send the L4S marking response comprises to:
send the L4S marking response from layer 3 to the SME; and
send the L4S marking response from the SME to the MLME.

13. The system of claim 8, wherein the L4S marking request comprises any one of (i) queue information for a corresponding L4S flow, (ii) characteristics of the corresponding L4S flow, (iii) a recommended value for congestion marking, or (iv) any combination of (i)-(iii).

14. The system of claim 8, the processing unit being further operative to:
receive from a sending device a frame with an Explicit Congestion Notification (ECN) flag field set to indicate congestion, wherein the sending device is operable to predict congestion based on any one of (i) a delay in a transmission queue, (ii) one or more drops, (iii) one or more retries, (iv) a backoff delay, (v) layer 2 Key Performance Indicators, (vi) a prediction generated by a machine learning technique, or (vii) any combination of (i)-(vi).

15. A non-transitory computer-readable medium that stores a set of instructions which when executed perform a method executed by the set of instructions comprising:
determining, in layer 2, a packet is experiencing congestion;
sending a Low Latency, Low Loss, Scalable Throughput (L4S) marking request to layer 3 to request congestion marking of the packet;
marking the packet in layer 3 for congestion experienced; and
sending a L4S marking response comprising the marked packet to layer 2.

16. The non-transitory computer-readable medium of claim 15, wherein sending the L4S marking request to layer 3 comprises:
sending the L4S marking request from a Medium Access Control (MAC) sublayer to a Link Layer Control (LLC) sublayer; and
sending the L4S marking request from the LLC sublayer to layer 3.

17. The non-transitory computer-readable medium of claim 16, wherein sending the L4S marking response comprises:
sending the L4S marking response from layer 3 to the LLC sublayer; and
sending the L4S marking response from the LLC sublayer to the MAC sublayer.

18. The non-transitory computer-readable medium of claim 15, wherein sending the L4S marking request to layer 3 comprises:
sending the L4S marking request from a MAC Layer Management Entity (MLME) to a Station (STA) Management Entity (SME); and
sending the L4S marking request from the SME to layer 3.

19. The non-transitory computer-readable medium of claim 18, wherein sending the L4S marking response comprises:
sending the L4S marking response from layer 3 to the SME; and
sending the L4S marking response from the SME to the MLME.

20. The non-transitory computer-readable medium of claim 15, wherein the L4S marking request comprises any one of (i) queue information for a corresponding L4S flow, (ii) characteristics of the corresponding L4S flow, (iii) a recommended value for congestion marking, or (iv) any combination of (i)-(iii).
